(19) United States
(12) Patent Application Publication
(10) Pub. No.: US 2011/0050462 A1
(43) Pub. Date: Mar. 3, 2011

(54) Finders keepers locator

(76) Inventor: James LaGreca, Cedarhurst, NY (US)

(21) Appl. No.: 12/806,983

(22) Filed: Aug. 25, 2010

Related U.S. Application Data
(60) Provisional application No. 61/275,032, filed on Aug. 25, 2009.

(51) Int. Cl. G08G 1/123

(52) U.S. Cl. 340/990; 340/993

(57) ABSTRACT

The present invention provides a transmitting and receiving system that is specially designed to quickly find an automobile when lost in a parking lot or public parking garage. The transmitter unit is installed in a selected location within a vehicle or other object and operates on power supplied by an internally contained, lithium battery. In addition to the battery, the transmitter unit comprises electrical and electronic components, antenna, and circuitry enclosed within a rectangular, plastic case, similar in size and shape of a car remote.

### CLAIM OF PRIORITY

This patent application claims priority under 35 USC 119(e)(1) from U.S. Provisional Patent Application Ser. No. 61/275,032 filed Aug. 25, 2009, of common inventorship herewith entitled, “Finders Keepers Locator.”

### FIELD OF THE INVENTION

The present invention pertains to the field of locators and more specifically to the field of locators utilizing Global Positioning Satellite (GPS) technology.

### BACKGROUND OF THE INVENTION

The prior art has put forth several designs for locators. Among these are:

U.S. Pat. No. 6,366,202 to Lawrence D. Rosenthal describes a paired lost item finding system based on the utilization of acoustic signals of 6500 Hz to broadcast a search signal to locate an item attached to one of a pair of item locators.

U.S. Pat. No. 6,674,364 to Paul Robert Holbrook et al describes an object finder comprising a wireless transmitter for producing a unique digital signal or data packet for a codable wireless receiver coded to respond only to the specific transmitter to cause the receiver to emit an audio signal for locating a misplaced object.

U.S. Pat. No. 6,956,475 to Jeffrey F. Hill describes a selectable lost item locator system including a radio frequency transmitter assembly and an additional radio receiver assembly.

None of these prior art references describe or suggest the present invention.

### SUMMARY OF THE INVENTION

It is an object of the present invention to provide an improved locator comprising Global Positional Satellite technology.

It is a further object of the present invention to provide a device to assist primarily in locating one's parked car. Up to five items can be located with this device, which includes a car.

### BRIEF DESCRIPTION OF THE DRAWINGS

FIG. 1 shows a perspective view of the locator of the present invention showing controls and indicator lights.

FIG. 2 shows a perspective view of the home based pager/cradle of the present invention. If the “Finders Keepers” device is lost, the portable “Home Base Pager” is used to find the “Finders Keepers Device” that contains the five locator transmitter sections.

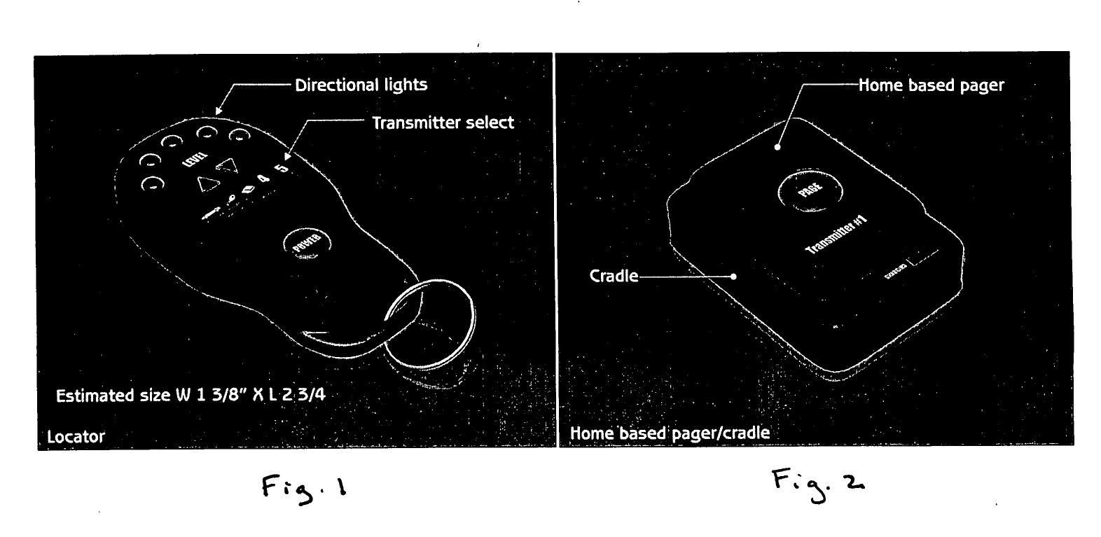

### DETAILED DESCRIPTION OF THE INVENTION

To accommodate the ever growing population of automotive vehicles, parking lots and public parking garages dot the urban landscape and new ones are constantly being built. Even with the many parking lots available, drivers frequently encounter two problems associated with parking lots which is finding an open parking space and, upon returning, finding the car. While it can be frustrating circling around a parking lot in hopes of locating a prime parking space, this challenge is minimal compared to the quandary experienced when one cannot relocate where they parked. While losing the car in such a manner can certainly be embarrassing, it is more annoying and frustrating, especially when returning from shopping with arms loaded with heavy bags, or in the pouring rain or under the blazing sun. Moreover, searching for one's parked car after dark can be quite dangerous, as hapless wandering can leave one susceptible to attack.

The present invention, hereinafter referred to as the Finders Keepers locator, provides a simple and practical solution to the aforementioned problem. As the name implies, the Finders Keepers is just that, a transmitting and receiving system that is specially designed to quickly find an automobile when lost in a parking lot or public parking garage. The transmitter unit is installed in a selected location within a vehicle or other object and operates on power supplied by an internally contained, lithium battery. In addition to the battery, the transmitter unit comprises electrical and electronic components, antenna, and circuitry enclosed within a rectangular, plastic case, similar in size and shape of a car remote.

A specially designed electronic transmitter, this device uses Global Positioning System (GPS) technology to monitor the specific whereabouts of the automobile within a possible range of up to one quarter (0.25) of a mile. Internally contained within the transmitter, a specialized computer chip is equipped with a tiny antenna which sends signals to the designated GPS satellite. The satellite transmits this information to a companion receiver equipped with a screen that either utilizes LEDs (light emitting diodes) or an LCD (Liquid Crystal Display) to graphically display the whereabouts of the auto and pinpoint its exact location.

The Home Base Pager is a separate unit used specifically to locate the Finders Keepers device if it should get lost. The Home Base Pager is located in the home of the owner of the Finders Keepers device. It is a portable device, so if the Finders Keepers device is lost within the house, it can be found with the Home Base Pager. If it is lost outside the house, the Home Base Pager can be taken outside of the house to find the Finders Keepers device. The receiver is powered using standard alkaline batteries or a rechargeable battery source, such as lithium, nickel-cadmium or nickel-metal hydride.

The Global Positioning System consists of 24 earth-orbiting satellites. This technology allows any motorist to know the precise location of his vehicle within a quarter of a mile of the receiver. When the receiver button is pressed, GPS satellites send out radio signals to be detected by the computer chip inside the Finders Keepers transmitter device. The antenna communicates with at least four satellites overhead, which is the minimum number needed for calculating position information such as altitude, latitude, and longitude. The receiver's display screen is equipped with an electronic range map stored in its memory. This device takes the coordinate information supplied by the GPS satellites and applies it to its internal, electronic map, graphically pointing out the direction in which the vehicle is located, as well as displaying a numerical range (measured in feet) between the receiver (which the user is holding) and the transmitter (inside the car). Viewing the LCD screen, the user can follow the direction displayed, and quickly find the lost automobile.

There are several significant benefits and advantages associated with this clever invention. Foremost, the Finders Keepers provides motorists with a simple and effective means of quickly locating an automobile in large parking lots or public parking garages. Utilizing the amazing technology of GPS, this easy to use device significantly increases the chances that an elusive car can be found in an expedient manner. As a result, consumers are able to avoid spending countless minutes fruitlessly searching for their vehicle, especially in inclement weather. With the simple pressing of a button on the receiver unit, the precise location of the car, and its distance away, is graphically displayed in seconds. The time savings afforded by the Finders Keepers is particularly beneficial to those driving alone and returning to their cars after nightfall, or in an unfamiliar area.

Although locating a lost vehicle has been the primary focus of the present invention, it should be noted that this inventive concept is envisioned to include lost personal items, such as keys, cell phones, and eyeglasses, to name just a few possibilities. If the Finders Keepers device is lost, the portable Hope Base Pager is used to find the Finders Keepers Device. The Finders Keepers device contains the five locator transmitter sections which work with the independent transmitters which are installed or attached to the objects one wants to find. Manufactured of durable, high quality materials and components, this product will withstand years of continued use.

The present invention comprises a device capable of locating up to five objects. The transmitters are portable devices that can be put on anything, from a car to a child. The Finders Keepers provides an affordable location device that can be installed in a fairly short time, eliminating the problem of not being able to locate a vehicle in a parking lot or other elusive object. Saving individuals the time and effort expended while searching for the vehicle or other object, this very big advantage will be beneficially used and appreciated by the general and motoring public.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An item locating system, comprising:
a transmitting and receiving system that is specially designed to quickly find an automobile when lost in a parking lot or public parking garage, wherein the transmitter unit is installed in a selected location within a vehicle or other object and operates on power supplied by an internally contained, lithium battery, further comprising electrical and electronic components, antenna, and circuitry enclosed within a rectangular, plastic case, similar in size and shape of a car remote.

2. The item locating system of claim 1 wherein the device uses Global Positioning System (GPS) technology to monitor the specific whereabouts of the automobile within a possible range of up to one quarter (0.25) of a mile.

3. The item locating system of claim 1 wherein the transmitter comprises a computer chip equipped with an antenna which sends signals to the designated GPS satellite and wherein the satellite transmits the signal to a companion receiver equipped with a screen that utilizes LEDs (light emitting diodes) or an LCD (Liquid Crystal Display) to graphically display the whereabouts of the auto and pinpoint its exact location.

4. The item locating system of claim 1 further comprising a home base pager to locate the device if it should get lost wherein the home base pager is located in the home of the owner of the device. And wherein the home base pager is portable, so if the device is lost within the house, it can be found with the home base pager, and wherein if the device is lost outside the house, the home base pager can be taken outside of the house to find the device.

5. The item locating system of claim 4, wherein the receiver is powered using alkaline batteries or a rechargeable battery source, selected from the group consisting of lithium, nickel-cadmium and nickel-metal hydride.

6. The item locating system of claim 2, wherein the Global Positioning System consists of 24 earth-orbiting satellites, allowing a motorist to know the precise location of his vehicle within a quarter of a mile of the receiver by pressing a receiver button, the GPS satellites send out radio signals to be detected by the computer chip inside the transmitter device which signals the antenna communicating with at least four satellites overhead, and the display screen on the receiver is equipped with an electronic range map stored in its memory, taking the coordinate information supplied by the GPS satellites and applies it to its internal, electronic map, graphically pointing out the direction in which the vehicle is located, as well as displaying a numerical range (measured in feet) between the receiver (which the user is holding) and the transmitter (inside the car), and the user can view the screen and, the user can follow the direction displayed, and quickly find the lost automobile.

7. The item locating system of claim 6 wherein the screen utilizes LCD (liquid crystal display) technology.

8. The item locating system of claim 6 wherein the screen utilizes LED (light emitting diode technology.
